(19) United States
(12) Patent Application Publication
(10) Pub. No.: US 2009/0212035 A1
(43) Pub. Date: Aug. 27, 2009

(54) Glow plug and methods for the production thereof

(76) Inventors: Mathias Herrmann, Coswig (DE); Hagen Klemm, Dresden (DE); Tassilo Moritz, Freiberg (DE); Reinhard Lenk, Dresden (DE); Hans-Juergen Richter, Dresden (DE); Andreas Goettler, Ulm (DE)

Correspondence Address: JACOBSON HOLMAN PLLC, 400 SEVENTH STREET N.W., SUITE 600, WASHINGTON, DC, 20004, US

(21) Appl. No.: 11/629,122

(22) PCT Filed: Jun. 10, 2005
(86) PCT No.: PCT/DE2005/001079

§ 371 Date: Oct. 14, 2008

(30) Foreign Application Priority Data
Jun. 11, 2004 (DE) 102004029322.8
Jun. 29, 2004 (DE) 102004033153.7

(51) Int. Cl. F23Q 7/00; C04B 35/584

(52) U.S. Cl. 219/270; 264/614

(57) ABSTRACT

The invention relates to a spark plug and method for manufacturing it, which spark plug has been manufactured from one electrically conductive element and one electrically non-conductive element, sintered composite ceramic material having been used for the manufacture. These spark plugs can preferably be used for stationary-mode heaters, operated with fuels, of motor vehicles. According to the object which is set, it should be possible to manufacture such spark plugs cost-effectively and flexibly and at the same time provide an extended service life and oxidation resistance. The conductive element here is to be embraced on two opposite sides by the electrically non-conductive element and it has an enlarged cross section in the distal region while a cross-sectional ratio of between 2.5 and 5 to 1 is maintained with respect to the cross section of the electrically conductive element. The cross-sectionally tapered proximal heating region of the electrically conductive element is covered by 60 to 85% of its surface by the material of the electrically non-conductive element.

The invention relates to glow plugs and to a method for manufacturing such glow plugs. The glow plugs according to the invention have one electrically conductive element and one electrically non-conductive element made of sintered ceramic composite material. The electrically conductive element embraces the electrically non-conductive element essentially from two opposite sides and has an enlarged cross section in a distal region and in a proximal region has a heating region which tapers with respect to the distal region.

Glow plugs according to the invention can preferably be used in stationary-mode heaters which are operated with fuels, such as are installed nowadays in many motor vehicles.

Said glow plugs are subjected in this context to temperatures above 1200° C. so that it is already known from the prior art to use ceramic composite materials to manufacture such glow plugs whose electrical conductivity can be influenced selectively by corresponding consistency of ceramic composite materials in order to be able to maintain electrically conductive and electrically non-conductive properties in certain regions of such glow plugs.

DE 100 53 327 C2 discloses using ceramic composite materials containing MoSi₂ and Si₃N₄. The electrical conductivity is selectively influenced here by correspondingly different proportions of these components. Accordingly, with increased proportions of MoSi₂ it is possible to significantly increase the electrical conductivity, and in contrast with relatively small components of MoSi₂ it is possible to manufacture or form electrically insulating parts or regions.

Since the glow plugs which are known from the prior art are to be completed, by sintering after a multi-stage injection moulding method, sinter additives are also additionally contained in the starting material composite.

However, certain properties are necessary for the injection mouldings so that the proportion of mixed-in organic components in the solid, usually pulverous starting materials and specifically the MoSi₂, the Si₃N₄ and the sinter additives is increased.

However, these organic components have to be completely expelled since a glow plug which is manufactured from purely inorganic material is desired.

However, the expulsion of the organic materials is made difficult by the structure of the moulding which is available after the injection process, on the one hand due to its forming and on the other hand due to the consistency of the material composite so that a considerable amount of time becomes necessary to expel the organic materials. For the expulsion process, open pore channels have to be formed by selective heating, said pore channels subsequently permitting the organic materials to escape from the interior. However, the pore channels are formed in a successive, relatively slow fashion starting from the surface.

Furthermore it is necessary to take account of the fact that these pore channels are subsequently closed again as far as possible during a sintering process and fracture formation has to be avoided in all cases.

The glow plugs which are known from the prior art are however critical under many conditions of use since they have a tendency to oxidize due to the ceramic composite materials used, which has a disadvantageous effect on the service life and the achievable efficiency during use.

For this reason, the object of the invention is to make available such glow plugs which can be manufactured cost effectively and flexibly and which have an extended service life and oxidation resistance.

This object is achieved according to the invention with glow plugs which have the features of Claim 1. They can be manufactured with a method such as is defined with Claim 12.

Advantageous embodiments and developments of the invention can be achieved with the features designated in the respective subordinate claims.

The glow plugs according to the invention having the two elements which have a respectively different electrical conductivity and are composed of a sintered ceramic composite material are embodied here in such a way that for the electrically conductive element a cross-sectional ratio of between 2.5 and 5 to 1 is maintained for the distal region which has an enlarged cross section with respect to the proximal heating region with a tapering cross section, and furthermore 60 to 85% of the surface of the proximal heating region is covered by the material which forms the electrically non-conductive element.

This reduces the surface of the electrically conductive element which is heated when an electric voltage is applied and enters into direct contact with the fuel combustion gas mixture.

Large surface areas of the electrically conductive element in the proximal heating region are correspondingly surrounded on three sides by electrically non-conductive ceramic composite material and are thus protected against oxidation. The insulating layer which covers the electrically conductive ceramic composite material should have a boundary face with a thickness >100 μm at 0.5 to 0.9.

Furthermore, the electrical line resistance of the distal region should be in the range between 10 and 40% with respect to the entire electrical line resistance of an electrically conductive element owing to the correspondingly enlarged cross section of said distal region.

For the respective ceramic composite materials it is possible to add, as starting materials, MoSi₂, Si₃N₄ and at least one sinter additive, in particular the ratio of MoSi₂ to Si₃N₄ determining the electrical conductivity, and correspondingly increased proportions of MoSi₂, preferably at least 60% by weight, should be contained in the electrically conductive element. In contrast to this, the proportion of MoSi₂ in the electrically non-conductive element should be in the region of approximately 40% by weight, and if appropriate even below it.

Since, as already mentioned at the beginning, the glow plugs according to the invention are also to be used in increased temperature ranges, as far as possible highly refractive sinter additives should be used. In this context, in particular rare earth oxides such as, for example, Y₂O₃ are preferred. However, it is of course possible to use mixtures of rare earth oxides as sinter additives.

However, other oxides should not be contained as sinter additives or impurities since they tend to experience strong oxidation under the conditions of use in question. Thus, the situation should in particular be avoided in which Al₂O₃ or else MgO is contained in the ceramic composite. In this context, already very small proportions of such oxides have a correspondingly disadvantageous effect even below 0.5% by mass and lead to considerable shortening of the achievable service life of such glow plugs. The powder mixture used should be completely free of aluminium and aluminium oxide, which is understood to mean a minimum proportion ≦1000 ppm.

A preferred sinter additive to be used can be Y₂O₃ which itself can form a proportion of approximately 10% by weight. However, it is also possible to use a mixture of rare earth oxides. In such a case, at least one further rare earth oxide with R₂O₃ can additionally be used, in which case R can be La . . . Lu, Sc. In this context, a ratio of Y₂O₃/(Y₂O₃+R₂O₃) in the range from 0 to 0.9, in particular preferably in the range from 0.3 to 0.8, should be maintained. The mol ratio (Y₂O₃+R₂O₃)/SiO₂ in the finished ceramic composite material should be ≦0.55 to 1 in order to be able to maintain the desired high temperature resistance over an extended service life.

Elements and chemical compounds such as, for example, Mo, W, WC, MoO₃, Mo₅Si₃, can also advantageously be added to the starting material composite. This also results in the possibility of reactive formation of MoSi₂ during the sintering, while the reactively formed MoSi₂ proportion or WMoSi₂ proportion should be in the range between 0.5 to 10% by weight.

Correspondingly, during the sintering process sinter necks are formed which advantageously influence the electrical conductivity. A relatively high proportion of reactively formed MoSi₂ should however be avoided since this causes the reproducibility of the compression of the ceramic composite material during the sintering to become worse.

The ceramic composite material which is finished by sintering can also additionally contain Mo₅Si₃ as well as the MoSi₂, in which case a proportion of Mo₅Si₃ above 15% by weight, preferably above 10% by weight, should be avoided.

In order to form and dimension the two essential elements of the glow plug according to the invention, attention should also be paid to the fact that as far as possible a continuous junction should be maintained between the distal region and proximal heating region of the electrically conductive element by avoiding a sudden transition. This not only has an advantageous effect on the electrical properties but also during sintering since shrinkage fractures and stresses can thus be very largely avoided.

The respective cross section of the proximal heating region which tapers with respect to the distal region should be formed tapering as far as possible approximately uniformly in the two possible dimensions, which can be achieved, for example, with a rotational symmetrical or approximately rotationally symmetrical cross section in this region.

An oxidation prevention layer should advantageously also be formed on a spark plug according to the invention, in which case this oxidation prevention layer should at least cover the distal region of a spark plug. This reduces the possibility of soot particles which may under certain circumstances be formed during operation from becoming deposited on the electrically non-conductive part change the electrical conductivity or even cause a short circuit, which in turn can lead to an adverse effect on the closed-loop or open-loop control of the temperature at the proximal heating region.

Oxidation prevention layers may be formed, for example, from glass, SiO₂ or ceramic, preferably Si₃N₄. The oxidation prevention layers can be formed using precursors such as siloxanes or silanes by glazing or reactive glazing.

Furthermore, it is also possible to form a relatively thin oxidation prevention layer from SiO₂ by converting MoSi₂ to SiO₂ which can be brought about by oxidation.

The inventive manufacture of glow plugs can be carried out in such a way that the two essential elements of the glow plugs are composed of a powder mixture of the composite ceramic material are used with a respectively suitable composition, in particular as far as the proportions of MoSi₂ and, if appropriate, additionally contained Mo₅Si₃ contained in the powder mixtures in relation to the respective proportion of Si₃N₄ with which the respectively desired electrical conductivity can be essentially influenced, and are subjected to preliminary forming before the actual sintering process.

In one alternative to this there is a possibility of also subjecting the electrically non-conductive element to forming by injection moulding in a way which is known from the prior art, and to manufacture it in this way. However, according to the invention, at least the electrically conductive element which is to be manufactured from a second suitable powder mixture is subjected to a colloidal forming method and in the process integrally moulded onto the previously obtained moulding for the electrically non-conductive element. However, the procedure can also be carried out in such a way that the electrically non-conductive element is integrally moulded onto an electrically conductive element.

After the electrically conductive element has been integrally moulded on, organic components which are contained, and under certain circumstances also further volatile components, for example, a liquid, are expelled. In addition, the completion of the glow plugs by a sintering process which is conventional per se and should be preferably carried out in a protective gas atmosphere then takes place.

If the mouldings both for the electrically conductive element and for the electrically non-conductive element are manufactured by means of a colloidal forming method or in particular also by an injection moulding method for the electrically non-conductive element, the mouldings for electrically non-conductive elements should be subjected in advance to temperature treatment in order to expel at least the organic components before the attachment by integral moulding is carried out for the electrically conductive element.

For example gel casting but also what is referred to as “coagulation casting methods”, such as for example temperature-influenced or temperature-induced forming (TIF) are possible as colloidal forming methods.

In all cases, the pulverous starting materials, specifically MoSi₂, to which under certain circumstances Mo₅Si₃ is also added, Si₃N₄ and sinter additives in the form of rare earth oxides are used to manufacture a suspension which is formed from liquid, for example water or else an organic solvent. The suspension then contains further organic materials which can support the forming process. In this context, the proportion of organic components is significantly reduced compared to the proportion necessary for forming by means of injection moulding. The proportion of organic solvents will not be considered here.

If, for example, the forming is carried out with the gel casting method such as described by O. O. Omatete et al. in “Gel casting—a new ceramic forming process”; Am. Ceram. Soc. Bull. 70 (1991), pages 1641 to 1649, and also in U.S. Pat. No. 4,894,194, a suspension comprising the pulverous starting materials is used for the ceramic composite material with the respectively required proportions of the individual components of an electrically conductive or electrically non-conductive element, said suspension containing a monomer and a cross linking, agent and into which in addition an initiator which leads to gel formation and solidification can be added and/or the solidification can be achieved by increasing the temperature.

The suspension can be poured into a mould having a negative contour of the electrically non-conductive element or else of the glow plug contour. Within the mould, the monomer is polymerized, which leads to partial solidification of the suspension. In the process, the polymerization can be supported by heating so that the time necessary can be shortened.

The form used can have a sealed, nonporous surface so that parts of the suspension can be prevented from penetrating the moulding material.

After a sufficient rigidity of the moulding has been achieved within the mould by means of the polymerization which has taken place, the moulding which is obtained in this way can be removed from the mould, if appropriate dried, and the organic materials then expelled and a sintering process carried out.

However, it is also possible to use colloidal forming by means of the direct coagulation forming method (direct coagulation casting: DCC) such as is used by T. J. Graule et al. in “Casting uniform ceramics with direct coagulation”; CHEMTECH JUNE (1995), pages 31 to 37 and in EP 0 695 694 B1 and forming influenced by temperature (TIF), such as is described by N. S. Bell et al. in “Temperature Induced Forming”; application of bridging flocculation to near-ne form production of ceramic parts”; metallography periodical, 90 (1999) 6, pages 388 to 390 and in DE 197 51 696 A1. These two methods are based on eliminating or reducing electro-statically repellent forces between the dispersed ceramic powder particles by pH value shifting and/or changing the ion concentration (DCC) or increasing the temperature (TIF). The particulate coagulation achieved in this way also causes the suspension to solidify.

The necessary coagulation in the temperature influenced forming method (TIF) with a temperature increase to 65° C. can thus bring about sufficient solidification of the moulding which is obtained in this way.

If the moulding for the electrically non-conductive element has been manufactured in this mould and in a different mould or by moving additional elements from the previously used mould of the second electrically conductive element is to be integrally moulded on, the moulding for the electrically non-conductive element should be kept at this temperature if the second suspension/dispersion with the increased proportion of MoSi₂ or MoSi₂ with Mo₅Si₃ is to be poured into the interior of the mould.

In addition to the already mentioned colloidal forming method it is also possible to use forming by means of gelling of gelatine when the temperature is reduced, such as, for example, by Y. Chen et al. in “Alumina Casting based on gelation of gelatine”; J. europ. Ceram. Soc. 19 (1999), pages 271 to 275.

Solidification in order to form sufficiently solid moulding can, however, also be achieved using proteins or else by gelling starch with a corresponding increase in temperature. One possible way of bringing about solidification with proteins is known from EP 7 67 154 A1. Gelling by means of starch is described in EP 9 27 709 B1.

Furthermore, the solidification effect of a suspension containing particles for the ceramic composite material can also be achieved by cancelling out the effect of a dispersion promoter by removing or changing said dispersion promoter by means of a chemical reaction in the suspension/dispersion. This is known, for example, from EP 0 905 107 A2.

A further possible way in which solidification during the desired forming, which leads to the construction of mouldings, is disclosed in WO 93/22256 A1. In this context, a reduction of the solubility of organic components when the temperature changes within the respective suspension is utilized.

If the solidification which leads to the construction of a moulding is achieved only by changing the temperature, as is the case, for example, during the temperature-influenced forming method (TIF), a moulding which is obtained first, in particular the one which ultimately forms the electrically non-conductive element, should not be returned to the initial temperature before the suspension is poured into a mould for the integral moulding on and forming of the second moulding for the electrically conductive element.

The already mentioned colloidal forming method can be used in combination. For example, it is possible to firstly form the moulding for the electrically non-conductive element with a method and then to perform the integral moulding on of the moulding for the second electrically conductive element with another forming method.

However, in the respective forming methods the proportion of solid by volume contained in respective suspensions should be matched to one another so that uniform shrinkage can be achieved whenever drying/sintering occurs.

If the moulding for the electrically non-conductive element has been obtained by injection moulding, the moulding should be freed of organic components after the injection moulding process by a releasing agent before the integral moulding on of the moulding for the electrically conductive element is carried out with a different forming method by filling a mould with a corresponding suspension.

Before filling with an appropriate suspension is carried out, the open porosity which is produced with the release agent can be filled and closed off with the liquid which is used for the suspension of the electrically conductive element of the second component so that it is ensured that the open porosity of the released, injection moulded moulding of the electrically non-conductive element does not have a sucking action of the fluid in the suspension of the electrically conductive component.

Instead of the moulds already mentioned which have a sealed, non-porous surface, it is, however, also possible to use porous moulds which within limits also suck up the respective fluid, such as can be prepared, for example, from plaster.

In such a mould, the moulding which is prepared from the suspension is produced and afterwards per se known body forming process of the moulding which is obtained is left with a sufficiently high green strength in the not yet dried state. After this, the integral moulding on of a moulding for the electrically conductive element can be formed, for example, by gel casting, by a direct coagulation forming method (DCC) or else with some other colloidal forming method which has been explained and designated above.

In all cases, as far as possible the solid volume proportions in the two starting suspensions which are used should be set for an electrically conductive and an electrically non-conductive ceramic composite material in such a way that defects, such as for example, fractures owing to different drying shrinkage, can be avoided. At the same time, as far as possible large proportions of liquid by volume and large proportions of organic materials by volume should also be maintained.

The dried mouldings which have a sufficiently high green strength and are connected to one another can then be sintered to form a finished spark plug. However, before the actual sintering process, all the organic components should be expelled by thermal treatment.

After the sintering process, mechanical postprocessing can be carried out, during which, for example, selective, forming erosion of material can be carried out. Furthermore, contact elements for making electrical contact can be applied.

The colloidal forming methods to be used for at least one of the two elements of a glow plug require a significantly reduced proportion of organic materials compared to the known injection moulding technology so that both the manufacturing costs and the environmental load are reduced. The proportion of organic components contained in total in a suspension/dispersion used for this should be ≦10% by weight in relation to the proportion of solids.

Furthermore, proportions of hydrocarbons are critical and influence the sintering in a negative way since finely dispersed MoSi₂ already has a high tendency to oxidate at temperatures above 300° C.

The invention will be explained in more detail below by way of example.

In the drawing:

FIG. 1 shows an example of a glow plug according to the invention;

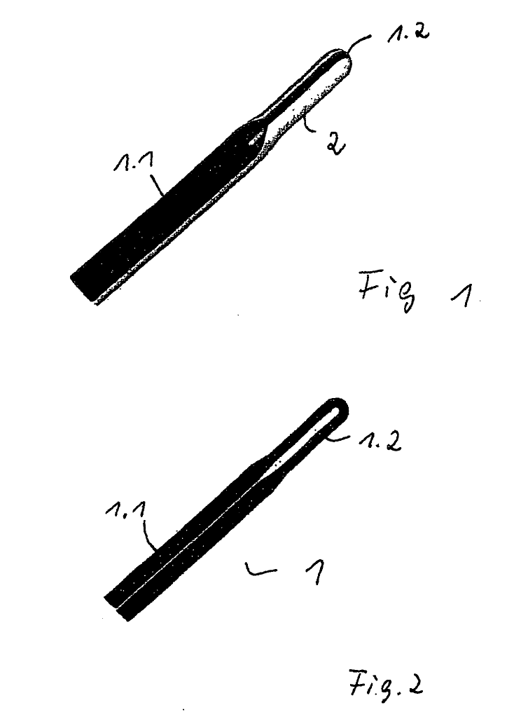

FIG. 2 is an electrically conductive element for the example according to FIG. 1;

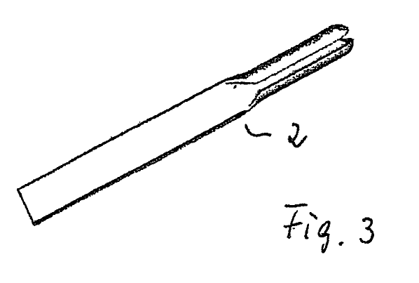

FIG. 3 is an electrically non-conductive element for a glow plug according to FIG. 1;

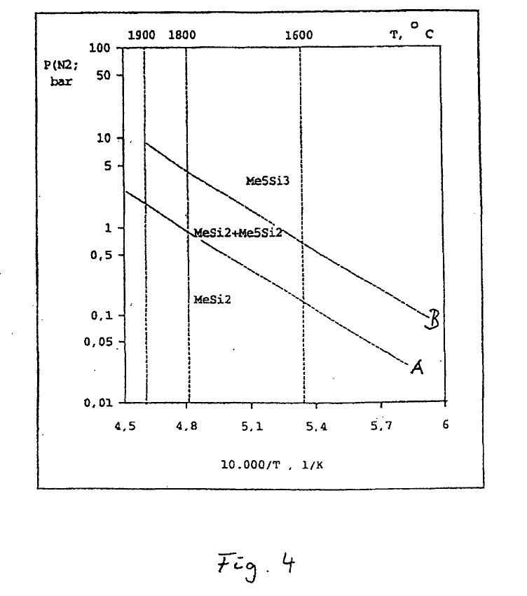

FIG. 4 is an oxygen pressure temperature diagram during sintering, and

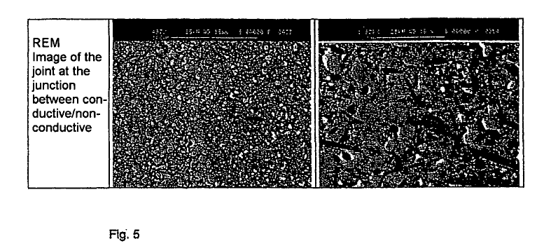

FIG. 5 shows REM micrographs of a completely sintered glow plug.

The glow plug shown in FIG. 1 is formed essentially from the two elements, specifically the electrically non-conductive element 2 and the electrically conductive element 1, with the last-mentioned element 1 being integrally moulded onto the electrically non-conductive element 2. As is clear in particular from FIG. 2, the electrically conductive element 1 is constructed in such a way that it has a distal region 1.1 with an enlarged cross section which adjoins a proximal heating region 1.2. The proximal heating region 1.2 has a cross section which tapers, that is to say becomes significantly smaller, compared to the distal region 1.1, which leads to an increase in the electrical line resistance in the proximal heating region 1.2. If the electrically conductive element 1 is then connected to an electric voltage source, the proximal heating region 1.2 heats up while the glow plug according to the invention is operating.

In the example of a glow plug according to the invention which is shown in FIG. 1, a cross-sectional ratio at the electrically conductive element of 3.5 to 1 is maintained for the distal region 1.1 in relation to the proximal heating region 1.2 with a correspondingly tapering cross section.

In particular in FIG. 1 it becomes clear that a surface area of 75% of the proximal heating region 1.2 is covered by the ceramic composite material of the electrically non-conductive element 2 so that the greater part in the surface region of the proximal heating region 1.2 has been surrounded.

In this example, the glow plug has an overall length of 50 mm. The proximal heating region 1.2 has a length of 16 mm in this example.

The cross section of the distal region 1.1 is 6 mm², and the cross section of the proximal heating region 1.2 is 2 mm² and is of rotationally symmetrical design. A uniformly progressive reduction in the cross section is provided only in the junction region between the distal region 1.1 and the proximal heating region 1.2. Otherwise, there are no changes in cross section in the distal region 1.1 or in the proximal heating region 1.2.

The glow plug is of symmetrical design with respect to a plane which is oriented parallel to the longitudinal axis of the glow plug.

Possible ways of manufacturing glow plugs according to the invention and suitable ceramic composite materials will be presented below.

### EXAMPLE 1

In order to manufacture an electrically non-conductive element 1, pulverous Si₃N₄ with an overall mass of 83.5 g (60.02% by weight), 44.5 g (31.98% by weight) pulverous MoSi₂ (Grade B commercially available from H.C. Starck, Germany) and pulverous Y₂O₃ Grade C, (commercially available from H.C. Starck, Germany) with a total weight of 1.13 g (8% by weight).

With this powder mixture and additionally 9.7 g acrylic acid amide, 0.8 g methylenediacrylic acid amide, 0.4 g synthetic polyelectrolyte, alkali free (available from Dolapix CA, Zschimmer and Schwarz, Germany) and 41.2 g deionized water, which has been set to a pH value of 10.5 with an NH₃ solution, a suspension is manufactured in a ball triturator. After degassing of the suspension, 4.5 g was added to a 5% aqueous ammonium peroxide sulphate solution. The suspension preferred in this way was poured into a corresponding negative mould made of plastic in which a suitable plastic core, having essentially the dimensions and contours of the electrically conductive element 1, was fixed.

After approximately 20 minutes, polymerization occurred, and could be accelerated by heating to a temperature of approximately 60° C. The mould should be kept closed in order to avoid evaporation of water.

The polymerization allowed sufficient green strength of the moulding to be achieved. The plastic mould was opened and the plastic core was removed.

After this, a second suspension for integrally moulding on a moulding for the electrically conductive element 1 was poured in.

For this, 46.7 g pulverous Si₃N₄ E-10 from UBE Industries, JP (26.95% by weight), 112.7 g pulverous MoSi₂ (Grade B, H.C. Starck, Germany) (65.03% by weight) and 13.9 g pulverous Y₂O₃ (Grade C, H.C. Starck, Germany) (8.02% by weight) was used.

This powder mixing was processed to form a solution with 11.4 g acrylic acid amide, 0.95 methylene diacrylic acid amide, 0.46 g synthetic polyelectrolyte, alkali free (from Dolapix CA, Zschimmer & Schwarz, Germany) and 38.5 g deionized water which was set to a pH value of 10.5 by means of NH₃ solution.

In a ball triturator, a conventional procedure is performed and after the degassing of the suspension 5.3 g was added to a 5% aqueous ammonium peroxide sulphate solution.

This solution was poured into the mould containing the moulding for the electrically non-conductive element 2.

The polymerization then took place, as already previously for the formation of the moulding for the electrically non-conductive element 2.

After sufficient solidification of the moulding for the electrically conductive element 1 also, the composite element was removed from the mould and it had sufficient green strength and could be dried. After this, the small proportion of organic materials was expelled and sintering occurred, allowing a finished spark plug to be made available.

The sintering of the composite element with green strength took place here in nitrogen atmosphere at a temperature of 1875° C., which was maintained over a time period of 3 hours. During the heating process, the nitrogen pressure was kept relatively low as a function of the respective temperatures, and increased successively until closed porosity was achieved, and it was then possible to increase the nitrogen pressure to approximately 50 bar in an isothermal sintering phase.

In this context, the nitrogen pressure can be increased to 2 bar at a sintering temperature below 1750° C., and then increased further to 6 bar.

The nitrogen pressure can preferably be set as a function of the respective temperature, as is clarified with FIG. 4.

In this context, in the case of pure MoSi₂ (MeSi₂) it should be reached below the lower dashed line A, or when there is additional Mo₅Si₃ (Me₅Si₃) below the line B, also illustrated by dashed lines in FIG. 4, until a closed porosity has been reached.

On a completely sintered glow plug a density >99.5% of the theoretical density could be achieved.

The two REM micrographs of the structure in the junction region between the electrically conductive element 1 (on the left) and electrically non-conductive element 2 (on the right) on the two micrographs, which only have a different degree of magnification here, clearly show a fracture-free junction which represents a solid bond.

The electrically conductive element 1 has a specifically electrical resistance 1.8·10⁻⁴ Ωcm, and the electrically non-conductive element 2 has a specific resistance of 800 Ωcm.

### EXAMPLE 2

In order to manufacture the electrically non-conductive element 2, 77.7 g (54.6% by weight), Si₃N₄, 53.2 g (37.40% by weight), MoSi₂, 11.4 g (8% by weight), Y₂O₃, 9.1 g acrylic acid amide, 0.7 g methylenediacrylic acid amide, 0.4 g synthetic polyelectrolyte and 37.0 g deionized water (pH value 10.5) are used and polymerized and solidified using 3.9 g of 5% aqueous ammonium peroxide sulphate solution, as in Example 1.

In order to form the electrically conductive element 1, 52.0 g Si₃N₄, 112.7 g MoSi₂, 8.6 Y₂O₃, 10.5 g methacrylic acid amide, 0.8 g methylene diacrylic acid amide, 0.46 g synthetic polyelectrolyte and 34.0 g deionized water (pH value 10.5) were used to manufacture a suspension. To the latter were added 4.5 g of a 5% aqueous ammonium peroxide sulphate solution and this was poured into a metal mould in order, as already in the Example 1, to achieve polymerization leading to solidification.

Using a previously used moulding core in the corresponding mould it was possible to perform integral moulding on of the two mouldings for the electrically conductive element 1 and an electrically non-conductive element 2.

After the removal from the mould, drying, releasing and sintering were in turn carried out analogously to Example 1.

### EXAMPLE 3

In order to manufacture an electrically non-conductive element 2, 88.2 g (61.38% by weight) Si₃N₄, 32.4 g (22.55% by weight), MoSi₂, 8.2 g (5.7% by weight), Mo₅Si₃ as well as 9.2 g Y₂O₃ as sintering additives and 5.7 g Yb₂O₃ (10.37% by weight) as a proportion of solids were used.

The latter were processed to form a suspension with 9.7 g acrylic acid amide, 0.8 g methylenediacrylic acid amide, 0.4 g synthetic polyelectrolyte and 41.2 g deionized water (pH value 10.5).

In order to form the electrically conductive element 1, 52 g (27.50% by weight) Si₃N₄, 107 g (56.58% by weight) MoSi₂, 15.2 g (8.04% by weight) Mo₅Si₃ and the sinter additives with 9.2 g Y₂O₃ and 5.7 g Yb₂O₃ (7.88% by weight), as a proportion of solids by means of 9.7 g acrylic acid amide, 0.8 g methylene diacrylic acid amide, 0.4 g synthetic polyelectrolyte and 41.2 g deionized water (pH value 10.5) were also processed to form a second suspension.

Furthermore, the procedure as already described in Example 1 was adopted and the polymerization was initiated by adding 5% aqueous ammonium peroxide sulphate solution.

1. Glow plug having one electrically conductive element and one electrically non-conductive element composed of sintered ceramic composite material, in which the electrically conductive element embraces the electrically non-conductive element from two opposite sides and has a distal region with an enlarged cross section as well as a proximal heating region, characterized in that a cross-sectional ratio at the electrically conductive element (1) of between 2.5 and 5 to 1 is maintained for the distal region (1.1) with respect to the proximal heating region (1.2) with a tapering cross section and
60 to 85% of the surface of the proximal heating region (1.2) is covered by material of the electrically non-conductive element.

2. Glow plug according to claim 1, characterized in that the electric line resistance of the distal region (1.1) is in the range between 10 and 40% of the entire electric line resistance of an electrically conductive element (1).

3. Glow plug according to claim 1, characterized in that the electrically conductive element (1) and electrically non-conductive element (2) are formed from MoSi₂, Si₃N₄ and at least one sinter additive, as a ceramic composite material with a respectively different specific electric resistance.

4. Glow plug according to claim 1, characterized in that exclusively rare earth oxides are contained as sinter additives.

5. Glow plug according to claim 1, characterized in that in addition Mo₅Si₃ with a maximum 15% by weight is contained.

6. Glow plug according to claim 1, characterized in that the glow plug is covered with an oxidation prevention layer at least in the distal region (1.1).

7. Glow plug according to claim 1, characterized in that the proximal heating region (1.2) is formed tapering at least approximately uniformly in cross section in the two dimensions.

8. Glow plug according to claim 1, characterized in that it is of symmetrical design with respect to a plane which is oriented parallel to the longitudinal axis.

9. Glow plug according to claim 1, characterized in that the electrically conductive element (1) is formed with at least 60% by weight MoSi₂ or MoSi₂ and Mo₅Si₃.

10. Glow plug according to claim 1, characterized in that at least some of the MoSi₂ has been formed reactively during the sintering.

11. Glow plug according to claim 1, characterized in that the oxidation prevention layer is formed from ceramic, glass or SiO₂.

12. Method for manufacturing a glow plug having one electrically conductive element and one non-conductive element composed of sintered ceramic composite material, in which a powder mixture of the ceramic composite material for the electrically conductive element (1) or the electrically non-conductive element (2) is subject to forming;
subsequent to the moulding obtained in this way the respective other element (1 or 2) is integrally moulded on by means of a second powder mixture and a colloidal forming method,
organic components which are then contained are expelled, and
the glow plug is completed by means of a sintering process.

13. Method according to claim 12, characterized in that both elements (1 and 2) are obtained by means of a colloidal forming method.

14. Method according to claim 12, characterized in that the moulding for the electrically non-conductive element (2) is obtained by injection moulding.

15. Method according to claim 12, characterized in that before the electrically conductive element (1) or electrically non-conductive element (1) is integrally moulded onto the moulding for the electrically non-conductive element (2), organic components are expelled from the latter.

16. Method according to claim 12, characterized in that the colloidal forming is carried out by means of gel casting and/or coagulation casting.

17. Method according to claim 12, characterized in that MoSi₂, Si₃N₄ and powder mixtures containing sinter additives are used, the proportion of MoSi₂ for the manufacture of electrically conductive element (1) reaching at least 50% by weight.

18. Method according to claim 12, characterized in that exclusively rare earth oxides are used as sintering aids.

19. Method according to claim 12, characterized in that powder mixtures which are completely free of aluminium and aluminium oxide are used.

20. Method according to claim 12, characterized in that the starting powder mixtures are used in a suspension during the colloidal forming.

21. Method according to claim 20, characterized in that the proportion of solids in the suspensions which are used for manufacturing the electrically conductive element (1) and the electrically non-conductive element (2) is the same in each case.

22. Method according to claim 12, characterized in that MoSi₂ is formed reactively with components which are additionally contained in the powder mixture or mixtures.

23. Method according to claim 12, characterized in that powder mixture or mixtures are used in which in addition Mo₅Si₃ is contained.

24. Method according to claim 12, characterized in that the proportion of organic components in a suspension for a colloidal forming method is ≦10% by weight.
